(19) United States
(12) Patent Application Publication
(10) Pub. No.: US 2026/0011735 A1
(43) Pub. Date: Jan. 8, 2026

(54) BINDER FOR ALL-SOLID-STATE BATTERY, NEGATIVE ELECTRODE FOR ALL-SOLID-STATE BATTERY INCLUDING SAME, AND ALL-SOLID-STATE BATTERY INCLUDING SAME

(71) Applicant: SAMSUNG SDI CO., LTD., Yongin-si, Gyeonggi-do (KR)

(72) Inventors: Jangwook LEE, Yongin-si, Gyeonggi-do (KR); Sangkyu LEE, Yongin-si, Gyeonggi-do (KR); Dongho KOO, Yongin-si, Gyeonggi-do (KR); Bohyung LEE, Yongin-si, Gyeonggi-do (KR); Eungyeong LEE, Yongin-si, Gyeonggi-do (KR)

(73) Assignee: SAMSUNG SDI CO., LTD., Yongin-si, Gyeonggi-do (KR)

(21) Appl. No.: 18/880,520

(22) PCT Filed: Mar. 22, 2024
(86) PCT No.: PCT/KR2024/003654

§ 371 Date: Dec. 31, 2024

(30) Foreign Application Priority Data
Jun. 21, 2023 (KR) 10-2023-0079989

(51) Int. Cl. H01M 4/62; H01M 10/0562

(52) U.S. Cl. CPC H01M 4/622; H01M 10/0562; H01M 2300/0068

(57) ABSTRACT

Disclosed are a binder for a negative electrode of an all-solid-state battery, a negative electrode of an all-solid-state battery including the same, and an all-solid-state battery including the same, and the binder includes a rubber-based binder and a sodium salt of carboxymethyl cellulose in a weight ratio of greater than 2:1 to 5:1.

### TECHNICAL FIELD

A binder for a negative electrode of an all-solid-state battery and an all-solid-state battery including the same are disclosed.

### BACKGROUND ART

Recently, the rapid supplement of electronic devices such as mobile phones, laptop computers, and electric vehicles, using batteries require surprising increases in demands for rechargeable batteries with relatively high capacity and lighter weight. Particularly, a rechargeable lithium battery has recently drawn attention as a driving power source for portable devices, as it has lighter weight and high energy density. Accordingly, research and development to improve the performance of rechargeable lithium batteries is being actively conducted.

An all-solid-state battery among rechargeable lithium batteries refers to a battery in which all materials are solid, and in particular, a battery using a solid electrolyte. One way to increase the energy density of these all-solid-state batteries is to use lithium metal as the negative electrode.

### DETAILED DESCRIPTION OF THE INVENTION

### Technical Problem

An embodiment provides a binder for a negative electrode of an all-solid-state battery that may provide an all-solid-state battery exhibiting excellent cycle-life characteristics.

Another embodiment provides a negative electrode of an all-solid-state battery including the binder.

Another embodiment provides an all-solid-state battery including the binder.

### Technical Solution

An embodiment provides a binder for a negative electrode of an all-solid-state battery including a rubber-based binder and a sodium salt of carboxymethyl cellulose in a weight ratio of greater than 2:1 to 5:1.

The all-solid-state battery may be a non-negative electrode precipitation-type all-solid-state battery.

The rubber-based binder may be a styrene butadiene rubber (SBR), a nitrile-butadiene rubber (NBR), a butadiene rubber (BR), a solution styrene butadiene rubber (SSBR), an ethylene propylene diene terpolymer (EPDM), or a combination thereof.

The weight ratio of the rubber-based binder and the sodium salt of carboxymethyl cellulose may be 2.5:1 to 5:1.

A weight average molecular weight (Mw) of the rubber-based binder may be 5,000 g/mol to 1,000,000 g/mol.

A degree of substitution of the carboxymethyl cellulose sodium salt may be 0.3 to 1.0.

Another embodiment provides a negative electrode for an all-solid-state battery including a current collector; and a negative electrode layer located on the current collector and including the binder.

The negative electrode layer may further include metal and amorphous carbon.

The metal may be Ag, Au, Sn, Zn, Al, Mg, Ge, Cu, In, Ni, Bi, Pt, Pd, or a combination thereof.

The amorphous carbon may be carbon black, acetylene black, denka black, ketjen black, furnace black, activated carbon, or a combination thereof.

Another embodiment provides an all-solid-state battery including the negative electrode; the positive electrode; and a solid electrolyte layer between the negative electrode and the positive electrode.

The solid electrolyte may be a sulfide-based solid electrolyte.

The all-solid-state battery may further include a lithium-containing layer formed between the current collector and the negative electrode layer during initial charging.

### Advantageous Effects

A binder for a negative electrode of an all-solid-state battery according to an embodiment may improve an adhesive strength between a current collector and a negative electrode layer, and also improve cycle-life characteristics of the all-solid-state battery.

### BRIEF DESCRIPTION OF THE DRAWINGS

FIG. 1 is a schematic view illustrating an all-solid-state battery according to an embodiment.

FIG. 2 is a schematic cross-sectional view showing the state of an all-solid-state battery after charging according to an embodiment.

FIG. 3 is a photograph showing a separation phenomenon of the negative electrode coating layer during the fabrication of an all-solid-state battery according to Example 1.

FIG. 4 is a photograph showing a separation phenomenon of the negative electrode coating layer during the fabrication of an all-solid-state battery according to Comparative Example 4.

FIG. 5 is a photograph showing a separation phenomenon of the negative electrode coating layer during the fabrication of an all-solid-state battery according to Comparative Example 5.

FIG. 6 is a photograph showing a separation phenomenon of the negative electrode coating layer during the fabrication of an all-solid-state battery according to Comparative Example 1.

FIG. 7 is a graph showing cycle-life characteristics of all-solid-state battery cells fabricated according to Examples 1 and 2 and Comparative Examples 2 and 3.

### BEST MODE FOR PERFORMING INVENTION

Hereinafter, embodiments of the present invention will be described in detail. However, these embodiments are merely examples, the present invention is not limited thereto, and the present invention is defined by the scope of claims.

The terminology used herein is used to describe embodiments only, and is not intended to limit the present disclosure. Expressions in the singular include a plurality of expressions unless the context clearly dictates otherwise.

As used herein, “combination thereof” means a mixture, a laminate, a composite, a copolymer, an alloy, a blend, a reaction product, and the like of the constituents.

Here, the term “comprise,” “include,” or “have” are intended to designate that the performed characteristics, numbers, step, constituted elements, or a combination thereof is present, but it should be understood that the possibility of presence or addition of one or more other characteristics, numbers, steps, constituted element, or a combination do not be precluded in advance.

The drawing shows that the thickness is enlarged in order to clearly show the various layers and regions, and the same reference numerals are given to similar parts throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and the like.

Unless otherwise defined in this specification, particle diameter or size may be an average particle diameter. This average particle size refers to the average particle size (D50), which means the diameter of particles with a cumulative volume of 50 volume % in the particle size distribution. The average particle diameter (D50) may be measured by methods well known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range, and from this, the average particle diameter (D50) value may be easily obtained through a calculation.

According to an embodiment, a binder for a negative electrode of an all-solid-state battery may include a rubber-based binder and a sodium salt of carboxymethyl cellulose in a weight ratio of greater than 2:1 to 5:1. Additionally, the weight ratio of the rubber-based binder and the sodium salt of carboxymethyl cellulose may be 2.5:1 to 5:1.

If the mixing ratio of the rubber-based binder and the sodium salt of carboxymethyl cellulose is greater than 2:1 and less than 1 by weight ratio, for example, 2:1, and further if the weight ratio of the rubber-based binder/sodium salt of carboxymethyl cellulose is less than 2/1, the materials forming the negative electrode layer may agglomerate, i.e., the particle dispersibility may deteriorate, and also the adhesive strength between the negative electrode layer and the current collector may be improved, and thus the charge/discharge efficiency, particularly the high-rate charge/discharge efficiency, may deteriorate, and the cycle-life characteristics may deteriorate. In addition, if the mixing ratio of the rubber-based binder and the sodium salt of carboxymethyl cellulose is greater than 5:1 by a weight ratio, for example, if the weight ratio of the rubber-based binder/sodium salt of carboxymethyl cellulose is greater than 5/1, it is difficult to prepare a slurry-type composition for forming a negative electrode coating layer, and the binder resistance increases, which may cause a problem of energy loss due to low voltage during high-rate discharge.

In this way, if the rubber-based binder and the sodium salt of carboxymethyl cellulose are used in the above mixing ratio, the effects of improving charge/discharge efficiency and cycle-life characteristics may be obtained.

In addition, even if the sodium salt of carboxymethyl cellulose and an aqueous binder are used together, if a binder such as polyvinyl alcohol or polyacrylic acid, rather than a rubber-based binder, is used, it is difficult to stably obtain the properties of a slurry-type composition for forming a negative electrode coating layer, and a coating layer including a binder such as polyvinyl alcohol or polyacrylic acid has low adhesive strength with a current collector, and thus detachment and peeling may occur during the battery assembly process, which is not suitable.

In an embodiment, the rubber-based binder may be a styrene butadiene rubber (SBR), a nitrile-butadiene rubber (NBR), a butadiene rubber (BR), a solution styrene butadiene rubber (SSBR), an ethylene propylene diene terpolymer (EPDM), or a combination thereof.

The rubber-based binder may have a weight average molecular weight (Mw) of 5,000 g/mol to 1,000,000 g/mol. The weight average molecular weight (Mw) of the rubber-based binder may be 5,000 g/mol to 500,000 g/mol, 5,000 g/mol to 100,000 g/mol, 5,000 g/mol to 80,000 g/mol, 20,000 g/mol to 80,000 g/mol, or 40,000 g/mol to 80,000 g/mol. If the weight average molecular weight (Mw) of the rubber-based binder is within the above range, it may exhibit appropriate dispersibility if manufacturing a negative electrode coating layer composition.

In an embodiment, the degree of substitution (DS) of the carboxymethyl cellulose sodium salt may be 0.3 to 1.0, 0.4 to 1.0, or 0.5 to 1.0. The degree of substitution of a cellulose compound refers to the average number of substituents substituted on cellulose per cellulose repeating unit, and for example, carboxymethyl cellulose may have three or less carboxymethyl groups per cellulose repeating unit, i.e., per unit. If the degree of substitution of the sodium salt of carboxymethyl cellulose is within the above range, it dissolves well in water and may maintain a solution state well.

A binder according to an embodiment may be usefully used in a negative electrode of an all-solid-state battery.

For example, the binder may be usefully used in a negative electrode layer comprising a current collector and a negative electrode layer on the current collector. The negative electrode layer may be a negative electrode active material layer or a negative electrode coating layer.

The negative electrode active material layer includes a negative electrode active material and may further include a binder, a conductive material, and/or a solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be nonspecific-shaped, or sheet-shaped, flake-shaped, spherical-shaped, or fiber-shaped natural graphite or artificial graphite, and the amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material, and the Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the amount of silicon may be 10 wt % to 50 wt % based on the total weight of the silicon-carbon composite. In addition, the amount of the crystalline carbon may be 10 wt % to 70 wt % based on the total weight of the silicon-carbon composite, and the amount of the amorphous carbon may be 20 wt % to 40 wt % based on the total weight of the silicon-carbon composite. In addition, a thickness of the amorphous carbon coating layer may be 5 nm to 100 nm.

The average particle diameter (D50) of the silicon particles may be 10 nm to 20 μm, for example 10 nm to 500 nm. The silicon particles may exist in an oxidized form, and in this case, an atomic amount ratio of Si:O in the silicon particles indicating a degree of oxidation may be a weight ratio of 99:1 to 33:67. The silicon particles may be SiOₓ particles, and in this case, the range of x in SiOₓ may be greater than 0 and less than 2. Here, the average particle diameter (D50) is measured by a particle size analyzer using a laser diffraction method, and refers to a diameter of particles having a cumulative volume of 50 volume % in the particle size distribution.

The Si-based negative electrode active material or Sn-based negative electrode active material may be mixed with the carbon-based negative electrode active material. A mixing ratio of the Si-based negative electrode active material or Sn-based negative electrode active material; and a carbon-based negative electrode active material may be 1:99 to 90:10.

In the negative electrode active material layer, the negative electrode active material may be included in an amount of 95 wt % to 99 wt % based on the total weight of the negative electrode active material layer.

In this case, the amount of the binder according to an embodiment may be 1 wt % to 5 wt % based on a total weight of the negative electrode active material layer. Additionally, the negative electrode active material layer may further include a conductive material. If the negative electrode active material layer further includes a conductive material, it may include 90 to 98 wt % of the negative electrode active material, 1 to 5 wt % of the binder, and 1 to 5 wt % of the conductive material. Herein, the amount of the negative electrode active material, the binder, and the conductive material may be a relative value calculated by considering the total weight of the negative electrode active material layer as 100 wt %.

The conductive material is used to provide conductivity to the electrode, and may include, for example, carbon-based materials such as natural graphite, artificial graphite, carbon black, acetylene black, ketjen black, a carbon fiber, and a carbon nanotube; a metal-based material in the form of metal powder or metal fibers, including copper, nickel, aluminum, and silver; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof. A thickness of the negative electrode collector may be 1 μm to 20 μm, 5 μm to 15 μm, or 7 μm to 10 μm.

If the negative electrode layer is a negative electrode coating layer, it means that the negative electrode is a precipitation-type negative electrode. The precipitation-type negative electrode may be a negative electrode which has no negative electrode active material during the assembly of a battery but in which a lithium metal and the like are precipitated during the charge of the battery and serve as a negative electrode active material. To explain this in more detail, if charging an all-solid-state battery, lithium ions are deintercalated from the positive electrode active material, pass through the solid electrolyte, and move toward the negative electrode, and are deposited on the negative electrode current collector, resulting in the formation of a lithium precipitation layer between the current collector and the negative electrode layer. A negative electrode having such a lithium precipitation layer is called a precipitation-type negative electrode, and a battery including such a negative electrode may be called a precipitation-type all-solid-state battery.

That is, a lithium precipitation layer may be formed between the current collector and the negative electrode layer. The lithium-containing layer may act as a lithium reservoir.

The charging process may be a formation process performed 1 time to 3 times at 0.05 C to 1 C at 25° C. to 50° C. If lithium is precipitated and deposited to form a lithium-containing layer, the lithium included in the lithium-containing layer is ionized and moves toward the positive electrode during discharge, so that this lithium may be used as a negative electrode active material.

A thickness of the lithium precipitation layer may be 2 μm to 50 μm. For example, the thickness of the lithium precipitation layer may be greater than or equal to 2 μm, greater than or equal to 5 μm, greater than or equal to 10 μm, greater than or equal to 20 μm, greater than or equal to 30 μm, or greater than or equal to 40 μm, and less than or equal to 50 μm, less than or equal to 40 μm, less than or equal to 30 μm, or less than or equal to 20 μm. If the thickness of the lithium precipitation layer is within the above range, there may be an advantage in that lithium may be reversibly precipitated during charge/discharge, thereby further improving cycle-life.

The negative electrode coating layer may include a metal, a carbon material, or a combination thereof that acts as a catalyst. In the negative electrode coating layer, for example, a metal may be supported on a carbon material, or a metal and a carbon material may be present in a mixture. In an embodiment, the negative electrode coating layer may include a metal and a carbon material.

The negative electrode coating layer may include amorphous carbon and metal particles. In this case, if the all-solid-state battery is charged, lithium ions are deintercalated from the positive electrode active material and deposited on the negative electrode current collector, which may result in further inclusion of a lithium precipitation layer between the current collector and the negative electrode layer. A negative electrode having such a lithium precipitation layer may be called a precipitation-type negative electrode.

The carbon material may be, for example, crystalline carbon, amorphous carbon, or a combination thereof, and may be amorphous carbon. The crystalline carbon may be, for example, natural graphite, artificial graphite, mesophase carbon microbeads, or a combination thereof. The amorphous carbon may be, for example, carbon black, acetylene black, denka black, ketjen black, furnace black, activated carbon, graphene, or a combination thereof. An example of the carbon black is Super P (Timcal). The amorphous carbon is not limited thereto, and may be any material classified as amorphous carbon in the relevant field.

The amorphous carbon may be a single particle, may have the form of a secondary particle in which a plurality of primary particles are aggregated, or a combination thereof.

A particle size of the single particle may be from 10 nm to 60 mm. Additionally, the particle size of the primary particles may be 20 nm to 100 nm, and the particle size of the secondary particles may be 1 μm to 20 μm.

In an embodiment, the particle diameter of the primary particle may be greater than or equal to 20 nm, greater than or equal to 30 nm, greater than or equal to 40 nm, greater than or equal to 50 nm, greater than or equal to 60 nm, greater than or equal to 70 nm, greater than or equal to 80 nm, or greater than or equal to 90 nm, and less than or equal to 100 nm, less than or equal to 90 nm, less than or equal to 80 nm, less than or equal to 70 nm, less than or equal to 60 nm, less than or equal to 50 nm, less than or equal to 40 nm, or less than or equal to 30 nm.

In an embodiment, the particle diameter of the secondary particles may be greater than or equal to 1 μm, greater than or equal to 3 μm, greater than or equal to 5 μm, greater than or equal to 7 μm, greater than or equal to 10 μm, or greater than or equal to 15 μm and less than or equal to 20 μm, less than or equal to 15 μm, less than or equal to 10 μm, less than or equal to 7 μm, less than or equal to 5 μm, or less than or equal to 3 μm.

The shape of the primary particles may be spherical, elliptical, plate-shaped, and combinations thereof. In an embodiment, the shape of the primary particles may be spherical, elliptical, and a combination thereof.

The metal may be any one selected from Ag, Zn, Al, Sn, Mg, Ge, Cu, In, Ni, Bi, Au, Si, Pt, Pd and combinations thereof, and in an embodiment may be Ag. If the negative electrode layer includes the metal, the electrical conductivity of the negative electrode may be improved.

The metal may be a metal particle, and the metal particle may have a size of 5 nm to 800 nm. The size of the metal particles may be greater than or equal to 5 nm, greater than or equal to 50 nm, greater than or equal to 100 nm, greater than or equal to 150 nm, greater than or equal to 200 nm, greater than or equal to 250 nm, greater than or equal to 300 nm, greater than or equal to 350 nm, greater than or equal to 400 nm, greater than or equal to 450 nm, greater than or equal to 500 nm, greater than or equal to 550 nm, greater than or equal to 600 nm, greater than or equal to 650 nm, greater than or equal to 700 nm, or greater than or equal to 750 nm. In addition, the size of the metal particles may be less than or equal to 800 nm, less than or equal to 750 nm, less than or equal to 700 nm, less than or equal to 650 nm, less than or equal to 600 nm, less than or equal to 550 nm, less than or equal to 500 nm, less than or equal to 450 nm, less than or equal to 400 nm, less than or equal to 350 nm, less than or equal to 300 nm, less than or equal to 250 nm, less than or equal to 200 nm, less than or equal to 150 nm, less than or equal to 100 nm, or less than or equal to 50 nm. If the size of the metal particles is within the above range, the battery characteristics (e.g., cycle-life characteristics) of the all-solid-state battery may be improved.

If the negative electrode coating layer includes a carbon-based material and metal particles, a mixing ratio of the carbon-based material and the metal particles may be a weight ratio of 1:1 to 99:1. For example, the weight of the carbon-based material relative to metal particles may be greater than or equal to 1, greater than or equal to 2, greater than or equal to 3, greater than or equal to 4, greater than or equal to 5, greater than or equal to 10, greater than or equal to 15, greater than or equal to 20, greater than or equal to 25, greater than or equal to 30, greater than or equal to 35, greater than or equal to 40, greater than or equal to 45, greater than or equal to 50, greater than or equal to 55, greater than or equal to 60, greater than or equal to 65, greater than or equal to 70, greater than or equal to 75, greater than or equal to 80, greater than or equal to 85, greater than or equal to 90, or greater than or equal to 95, and less than or equal to 99, less than or equal to 95, less than or equal to 90, less than or equal to 85, less than or equal to 80, less than or equal to 75, less than or equal to 70, less than or equal to 65, less than or equal to 60, less than or equal to 55, less than or equal to 50, less than or equal to 45, less than or equal to 40, less than or equal to 35, less than or equal to 30, less than or equal to 25, less than or equal to 20, less than or equal to 15, less than or equal to 10, less than or equal to 5, less than or equal to 4, less than or equal to 3, or less than or equal to 2. For example, the weight ratio of the carbon-based material to the metal particles may be 1:1 to 5:1, 1:1 to 10:1, 1:1 to 20:1, 1:1 to 30:1, 1:1 to 40:1, 1:1 to 50:1, 1:1 to 60:1, 1:1 to 70:1, 1:1 to 80:1, or 1:1 to 90:1. If the carbon-based material and the metal particles are included in the above weight ratio, the electrical conductivity of the negative electrode may be further improved.

The negative electrode coating layer includes a binder according to the above embodiment, and may further include a conductive material, and/or a solid electrolyte.

The conductive material is the same as that described in the above-mentioned negative electrode active material layer.

The solid electrolyte may be a sulfide-based solid electrolyte, an oxide-based solid electrolyte, or a combination thereof as described above for the positive electrode. The solid electrolyte included in the negative electrode may be the same as or different from the solid electrolyte included in the positive electrode.

The negative electrode layer may further include additives such as a filler, a dispersant, and an ion conductive material. In addition, known materials generally used in all-solid-state batteries may be used as the filler, dispersant, ion conductive material, etc. that may be included in the negative electrode layer. The thickness of the negative electrode layer may be 1 μm to 15 μm, or 5 μm to 10 μm.

The current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet. A thickness of the negative electrode current collector may be 1 μm to 20 μm, 5 μm to 15 μm, or 7 μm to 10 μm.

Another embodiment provides an all-solid-state battery including a positive electrode and the negative electrode, and a solid electrolyte layer between the negative electrode and the positive electrode.

According to an embodiment, the negative electrode may further include a lithium-containing layer formed during initial charging after battery fabricating between the current collector and the negative electrode layer.

In an embodiment, since the lithium-containing layer is located between the current collector and the negative electrode layer, the negative electrode coating layer may act as a protective layer of the lithium-containing layer, thereby suppressing the precipitation and growth of lithium dendrites. As a result, short circuiting and capacity reduction of the all-solid-state battery may be suppressed, and as a result, the cycle-life of the all-solid-state battery may be improved.

In an embodiment, the current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet. A thickness of the current collector may be 1 μm to 20 μm, 5 μm to 15 μm, or 7 μm to 10 μm.

The current collector may include a metal substrate and may further include a thin film formed on the substrate. The thin film may include an element that may form an alloy with lithium, and may be, for example, gold, silver, zinc, tin, indium, silicon, aluminum, bismuth, or a combination thereof, but is not limited thereto. In the technical field, any element that may form an alloy with lithium may be used. If the current collector further includes a thin film and the lithium precipitation layer is formed by precipitation during charging, a more flattened lithium precipitation layer may be formed, thereby further improving the cycle-life of the all-solid-state battery.

A thickness of the thin film may be 1 nm to 800 nm, 10 nm to 700 nm, 50 nm to 600 nm, or 100 nm to 500 nm. If the film thickness is within the above range, the cycle-life characteristics may be further improved.

Another embodiment provides an all-solid-state battery including the negative electrode, a positive electrode, and a solid electrolyte layer between the negative electrode and the positive electrode.

The solid electrolyte layer may include a solid electrolyte. The solid electrolyte in the solid electrolyte layer may be an inorganic solid electrolyte such as a sulfide-based solid electrolyte, an oxide-based solid electrolyte, or a halide-based solid electrolyte, or a solid polymer electrolyte. In an embodiment, the solid electrolyte may be a sulfide-based solid electrolyte, for example, an argyrodite-type sulfide-based solid electrolyte. The sulfide-based solid electrolyte is suitable because it has superior ionic conductivity compared to other solid electrolytes such as an oxide-based solid electrolyte, and may exhibit 10) excellent cycle-life characteristics over a wider operating range.

The sulfide-based solid electrolyte may be, for example Li₂S—P₂S₅, Li₂S—P₂S₅—LiX (wherein X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are integers of 0 or more and 12 or less and Z is one of Ge, Zn, or Ga), Li₂S—GeS₂, Li₂S—SiS₂—Li₃PO₄, Li₂S—SiS₂-LiₚMO_{q} (wherein p and q are each 0 or more and 12 or less and M is one of P, Si, Ge, B, Al, Ga, or In), or LiₐM_{b}P_{c}S_{d}Aₑ (wherein a, b, c, d, and e are each 0 or more and 12 or less, M is Ge, Sn, Si, or a combination thereof, and A is one of F, Cl, Br, or I). For example, it may be, for example, Li₂₋ₓPS₆₋ₓFₓ (0≤x≤2), Li₂₋ₓPS₆₋ₓClₓ (0≤x≤2), Li₂₋ₓPS₆₋ₓBrₓ (0≤x≤2), or Li₂₋ₓPS₆₋ₓIₓ (0≤x≤2). Additionally, it may be specifically Li₃PS₄, Li₃PS₄, Li₇P₃S₁₁, Li₇PS₆, Li₆PS₅Cl, Li₆PS₅Cl, Li₆PS₅Br, Li₆PS₅I, Li_{5.8}PS_{4.8}Cl_{1.2}, Li_{6.2}PS_{5.2}Br_{0.8}, etc.

The sulfide-based solid electrolyte may be obtained by, for example, mixing Li₂S and P₂S₅ in a mole ratio of 50:50 to 90:10 or 50:50 to 80:20. Within the above mixing ratio range, a sulfide-based solid electrolyte having excellent ionic conductivity may be prepared. The ionic conductivity may be further improved by adding SiS₂, GeS₂, B₂S₃, and the like as other components thereto. Mechanical milling or a solution method may be applied as a mixing method. The mechanical milling is to make starting materials into particulates by putting the starting materials, ball mills, and the like in a reactor and fervently stirring them. The solution method may be performed by mixing the starting materials in a solvent to obtain a solid electrolyte as a precipitate. Additionally, additional firing may be performed after mixing. If additional firing is performed, the crystals of the solid electrolyte may become more solid.

The sulfide-based solid electrolyte may be amorphous or crystalline, or may be a mixture of the two. Of course, a commercially available solid electrolyte may be used as the sulfide-based solid electrolyte. Of course, a commercially available sulfide-based solid electrolyte may also be used as the sulfide-based solid electrolyte.

The oxide-based inorganic solid electrolyte may be, for example, Li₁₊ₓTi_{z-x}Al(PO₄)₃ (LTAP) (0≤x≥4), Li_{1+x+y}AlₓTi₂₋ₓSi_{y}P_{3-y}O₁₂ (0≤x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y} (Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (M=Te, Nb, or Zr, and x is an integer of 1 to 10), or a mixture thereof.

The halide-based solid electrolyte may include a Li element, an M element (M is a metal other than Li), and an X element (X is a halogen). Examples of X may include F, Cl, Br, and I. In particular, in the halide-based solid electrolyte, at least one of Br and Cl is suitable as the above X. In addition, examples of M may include metal elements such as Sc. Y, B, Al, Ga, and In.

A composition of the halide-based solid electrolyte is not particularly limited, but may be represented by Li₆₋₃ₐMₐBr_{b}Cl_{c} (where M is a metal other than Li, 0<a<2, 0≤b≤6, 0≤c≤6, b+c=6). Herein, a may be 0.75 or more, 1 or more, and a may be 1.5 or less. The b may be 1 or more, and may be 2 or more. Additionally, c may be 3 or more, and may be 4 or more. Specific examples of the halide-based solid electrolyte may be Li₃YBr₆, Li₃YCl₆, or Li₃YBr₂Cl₄.

The solid polymer electrolyte may include, for example, one or more selected from polyethylene oxide, poly(diallyldimethylammonium) trifluoromethanesulfonylimide (poly(diallyldimethylammonium)TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na,Li)₁₊ₓTi₂₋ₓAlₓ(PO₄)₃ (0.1≤x≤0.9), Li₁₊ₓHf₂₋ₓAlₓ(PO₄)₃ (0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-silicates, Li_{0.3}La_{0.5}TiO₃, Na₅MSi₄O₁₂ (wherein M is a rare earth element of Nd, Gd, Dy, and the like), Li₅ZrP₃O₁₂, Li₅TiP₃O₁₂, Li₅Fe₂P₃O₁₂, Li₄NbP₃O₁₂, Li₁₊ₓ(M,Al,Ga)ₓ(Ge_{1-y}Ti_{y})₂₋ₓ(PO₄)₃ (0≤x≤0.8, 0≤y≤1.0, Mis Nd, Sm, Eu, Gd, Tb, Dy, Ho, Er, Tm, or Yb), Li_{1+x+y}QₓTi₂₋ₓSi_{y}P_{3-y}O₁₂ (0<x≤0.4, 0<y≤0.6, Q is Al or Ga), Li₆BaLa₂Ta₂O₁₂, Li₂La₇Zr₂O₁₂, Li₅La₃Nb₂O₁₂, Li₅La₃M₂O₁₂ (M is Nb, Ta), and Li₇₊ₓAₓLa₃₋ₓZr₂O₁₂ (0<x<3, A is Zn).

The solid electrolyte may in the form of particles, and an average particle diameter (D50) may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm.

The solid electrolyte layer may further include a binder. Herein, the binder may be styrene butadiene rubber, polytetrafluoroethylene, polyvinylidene fluoride, polyethylene, an acrylate-based polymer, or a combination thereof, but is not limited thereto, and anything used as a binder in the art may be used. The acrylate-based polymer may be butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof. A forming process of the solid electrolyte layer is well known in the art, and thus a detailed description thereof will be omitted.

The thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. An amount of the lithium salt in the solid electrolyte layer may be greater than or equal to 1 M, for example, 1 M to 4 M. In this case, the lithium salt may improve ionic conductivity by improving lithium ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoromethanesulfonyl)imide (LiTFSI, LiN(SO₂CF₃)₂), lithium bis(fluorosulfonyl)imide, LiFSi, LiN(SO₂F)₂), LiCF₃SO₃, LiAsF₆, LiSbF₆, LiClO₄, or a mixture thereof.

In addition, the lithium salt may be an imide-based salt, for example, the imide-based lithium salt may be lithium bis(trifluoromethane sulfonyl)imide (LiTFSI, LiN(SO₂CF₃)₂), and lithium bis(fluorosulfonyl)imide (LiFSi, LiN(SO₂F)₂). The lithium salt may maintain or improve ionic conductivity by appropriately maintaining chemical reactivity with the ionic liquid.

The ionic liquid has a melting point below room temperature, so it is in a liquid state at room temperature and refers to a salt or room temperature molten salt composed of ions alone.

The ionic liquid may be a compound including at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof, and at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyi)amide, and 1-ethyl-3-methylimidazolium bis(trifluoromethylsulfonyl)amide.

The positive electrode includes a positive electrode current collector and a positive electrode active material layer on one surface of the positive electrode current collector.

The positive electrode active material layer may include a positive electrode active material. The positive electrode active material may be a positive electrode active material capable of reversibly intercalating and deintercalating lithium ions, and for example, the positive electrode active material may be at least one of a composite oxide of lithium and a metal selected from cobalt, manganese, nickel, and a combination thereof. Examples of the positive electrode active material may include LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤0.5); LiₐNi_{1-b-c}Co_{b}B¹_{c}D¹_{c} (0.90≤a≤1.8, 0≤b≤0.5, 0≤c≤0.5, 0<a≤2); LiₐNi_{1-b-c}CO_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α} (0.90≤a≤1.8, 0≤b≤0.5, 0≤c≤0.5, 0<α≤2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QO₂; QS₂; LiQS₂; V₂O₅; LiV₂O₅; LiI¹O₂; LiNiVO₄; Li_{(3-f)}J₂(PO₄)₃ (0≤f≤2); Li_{(3-f)}Fe₂(PO₄)₃ (0≤f≤2); or LifePO₄.

In the above chemical formulas, A is Ni, Co, Mn, or a combination thereof; B¹ is Al, Ni, Co, Mn, Cr, Fe, Mg, Sr, V, a rare earth element, or a combination thereof; D¹ is O, F, S, P, or a combination thereof; E is Co, Mn, or a combination thereof; F¹ is F, S, P, or a combination thereof; G is Al, Cr, Mn, Fe, Mg, La, Ce, Sr, V, or a combination thereof; Q is Ti, Mo, Mn, or a combination thereof; I¹ is Cr, V, Fe, Sc, Y, or a combination thereof; J is V, Cr, Mn, Co, Ni, Cu, or a combination thereof; and L¹ is Mn, Al, or a combination thereof.

According to an embodiment, the positive electrode active material may be a ternary lithium transition metal such as LiNiₓCo_{y}Al_{z}O₂ (NCA), LiNiₓCo_{y}Mn_{z}O₂ (NCM) (wherein 0<x<1, 0<y<1, 0<z<1, x+y+z=1).

Also, the compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, and for example, the method may include any coating method such as spray coating, dipping, and the like, but is not illustrated in more detail since it is well-known in the related field.

In addition, as the coating layer, any known coating layer for the positive electrode active material of an all-solid-state battery may be applied, examples of which include Li₂O—ZrO₂ (LZO).

In addition, if the positive electrode active material includes nickel, cobalt and manganese, or nickel, cobalt and aluminum, the capacity density of the all-solid-state battery may be further improved and metal elution from the positive electrode active material in the charged state may be further reduced. Because of this, the long-term reliability and cycle characteristics of the all-solid-state battery may be further improved in a charged state.

Here, examples of the shape of the positive electrode active material include particle shapes such as spheres and ellipsoids-spheres. Additionally, the average particle diameter of the positive electrode active material is not particularly limited, and may be within a range applicable to the positive electrode active material of existing all-solid-state rechargeable batteries. Additionally, the amount of the positive electrode active material in the positive electrode active material layer is not particularly limited, and may be within a range applicable to the positive electrode layer of an existing all-solid-state rechargeable batteries.

The positive electrode active material layer may further include a solid electrolyte. The solid electrolyte included in the positive electrode active material layer may be the aforementioned solid electrolyte, and in this case, it may be the same as or different from the solid electrolyte included in the solid electrolyte layer. The solid electrolyte may be included in an amount of 10 wt % to 30 wt % based on a total weight of the positive electrode active material layer.

The current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet.

The positive electrode active material layer may further include a binder and/or a conductive material.

The binder may be polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, styrene-butadiene rubber, an acrylated styrene-butadiene rubber, an epoxy resin, nylon, and the like, but is not limited thereto.

The binder may be included in an amount of 0.1 wt % to 5 wt %, or 0.1 wt % to 3 wt %, based on a total weight of each component of the positive electrode for the all-solid-state battery, or based on a total weight of the positive electrode active material layer. Within the above amount range, the binder may sufficiently exhibit adhesive ability without deteriorating battery performance.

The conductive material is used to impart conductivity to the electrode, and any material that does not cause chemical change and conducts electrons may be used in the battery, and examples thereof may include a carbon-based material such as natural graphite, artificial graphite, carbon black, acetylene black, ketjen black, a carbon fiber, a carbon nanotube, and the like, a metal-based material including copper, nickel, aluminum, silver, etc. and in the form of a metal powder or a metal fiber, a conductive polymer such as a polyphenylene derivative, or a mixture thereof.

The conductive material may be included in an amount of 0.1 wt % to 5 wt %, or 0.1 wt % to 3 wt %, based on a total weight of each component of the positive electrode for the all-solid-state battery, or based on a total weight of the positive electrode active material layer. Within the above amount range, the conductive material may improve electrical conductivity without deteriorating battery performance.

A thickness of the positive electrode active material layer may be 90 μm to 200 μm. For example, the thickness of the positive electrode active material layer may be greater than or equal to 90 μm, greater than or equal to 100 μm, greater than or equal to 110 μm, greater than or equal to 120 μm, greater than or equal to 130 μm, greater than or equal to 140 μm, greater than or equal to 150 μm, greater than or equal to 160 μm, greater than or equal to 170 μm, greater than or equal to 180 μm, or greater than or equal to 190 μm, and less than or equal to 200 μm, less than or equal to 190 μm, less than or equal to 180 μm, less than or equal to 170 μm, less than or equal to 160 μm, less than or equal to 150 μm, less than or equal to 140 μm, less than or equal to 130 μm, less than or equal to 120 μm or less than or equal to 110 μm. As described above, because the thickness of the positive electrode active material layer is thicker than that of the negative electrode active material layer, the capacity of the positive electrode is greater than that of the negative electrode.

The positive electrode may be manufactured by forming a positive electrode active material layer on a positive electrode current collector by dry or wet coating.

In an embodiment, a cushioning material may be additionally included to buffer thickness changes that occur if the all-solid-state battery is charged and discharged. The cushioning material may be present between the negative electrode and the case, and in the case of a battery in which one or more electrode assemblies are stacked, it may be present between different electrode assemblies.

The cushioning material may include a material that has an elastic recovery rate of 50% or more and has an insulating function, and specifically includes silicone rubber, acrylic rubber, fluorine-based rubber, nylon, synthetic rubber, or a combination thereof. The cushioning material may be present in the form of a polymer sheet.

An all-solid-state battery according to an embodiment may be manufactured by positioning a negative electrode, a positive electrode, and a solid electrolyte layer between the negative electrode and the positive electrode to prepare a stack, and pressing the stack.

The pressing process may be performed in the range of 25° C. to 90° C. Additionally, the pressing process may be performed by pressing at a pressure of less than or equal to 550 MPa, for example less than or equal to 500 MPa, for example 1 MPa to 500 MPa. The pressing time may vary depending on temperature and pressure, and may be, for example, less than 30 minutes. The pressing process may include, for example, an isostatic press, a warm isostatic press. a roll press or a plate press.

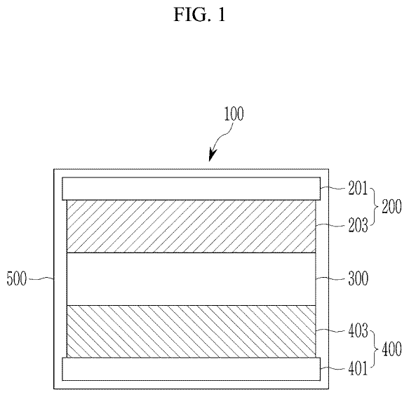

FIG. 1 is a cross-sectional view of an all-solid-state battery according to an embodiment. Referring to FIG. 1, the all-solid-state battery 100 includes an electrode assembly in which a negative electrode 400 including a negative electrode current collector 401 and a negative electrode layer 403, a solid electrolyte layer 300, and a positive electrode 200 including a positive electrode active material layer 203 and the positive electrode current collector 201 are stacked and a case such as a pouch housing the electrode assembly. The all-solid-state battery 100 may further include an elastic layer 500 on the outside of at least one of the positive electrode 200 and the negative electrode 400. Although FIG. 1 shows one electrode assembly including the negative electrode 400, the solid electrolyte layer 300, and the positive electrode 200, an all-solid-state battery may also be fabricated by stacking two or more electrode assemblies.

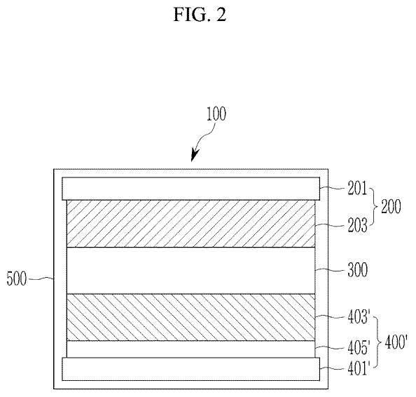

FIG. 2 schematically illustrates the structure of an all-solid-state battery including a precipitation-type negative electrode in a state of charging.

Referring to FIG. 2, a lithium precipitation layer 405′ is included between the current collector 401′ and the negative electrode layer 403″. This lithium precipitation layer 405′ may be formed by lithium ions being deintercalated from the positive electrode active material if the all-solid-state battery is charged and deposited on the negative electrode current collector 401′, and consequently located between the current collector 401′ and the negative electrode layer 403″. This lithium precipitation layer 405′ may be referred to as a negative electrode coating layer.

### MODE FOR PERFORMING THE INVENTION

Hereinafter, examples of the present invention and comparative examples are described. These examples, however, are not in any sense to be interpreted as limiting the scope of the invention.

### Example 1

### (1) Manufacturing of Negative Electrode

22.94 wt % of carbon black with an average particle diameter (D50) of 35 nm, 68.8 wt % of Ag with an average size of 60 nm, 6.2 wt % of a styrene-butadiene rubber (a weight average molecular weight (Mw): 50,000 g/mol), and 2.06 wt % of a sodium salt of carboxymethyl cellulose (a degree of substitution (DS): 0.8) were mixed in water to prepare a negative electrode coating layer slurry.

The negative electrode coating layer slurry was coated on a 10 μm-thick stainless steel foil current collector and then, vacuum-dried at 80° C. to manufacture a negative electrode. In the negative electrode, a negative electrode coating layer was formed to be 15 μm thick.

### (2) Manufacturing of Solid Electrolyte Layer

To an argyrodite-type solid electrolyte of Li₆PS₅Cl, an isobutyryl isobutyrate binder solution (a solid content: 50 wt %) to which an acrylate-based polymer of butyl acrylate was added, was added and then, mixed. Here, the solid electrolyte and the binder were mixed in a weight ratio of 98.7:1.3.

The mixing process was performed by using a Thinky mixer. Subsequently, 2 mm zirconia balls were added to the obtained mixture and then, stirred again by using a Thinky mixer to prepare slurry. The slurry was cast on a release polytetrafluoroethylene film and then, dried at room temperature to manufacture a 100 μm-thick solid electrolyte layer.

### (3) Manufacturing of Positive Electrode

A positive electrode active material of LiNi_{0.9}Co_{0.05}Mn_{0.05}O₂, an argyrodite-type solid electrolyte of Li₆PS₅Cl, a conductive material of a carbon nano fiber, and a binder of polytetrafluoroethylene (PTFE) were mixed in a solvent of N-methylpyrrolidone to prepare a positive electrode active material slurry. In the positive electrode active material slurry, the positive electrode active material, the solid electrolyte, the conductive material, and the binder had a weight ratio of 85:15:3:1.5.

The positive electrode active material slurry was coated on an aluminum foil and then, dried and compressed in a general method to manufacture a 120 μm-thick positive electrode having a 105 μm-thick positive electrode active material layer.

(4) Fabricating of all-Solid-State Half-Cells

The negative electrode, the solid electrolyte, and the positive electrode were sequentially stacked to fabricate a unit cell, and two unit cells were stacked and assembled and then, subjected to a warm isotropic pressing (WIP) process to fabricate an all-solid-state battery cell (full cell).

### Example 2

22.94 wt % of carbon black with an average particle diameter (D50) of 35 nm, 68.8 wt % of Ag with an average size of 60 nm, 5.9 wt % of a styrene-butadiene rubber (a weight average molecular weight (Mw): 50,000 g/mol), and 2.36 wt % of a sodium salt of carboxymethyl cellulose (a degree of substitution (DS): 0.8) were mixed in water to prepare a negative electrode coating layer slurry.

Except for using the negative electrode coating layer slurry, a negative electrode and an all-solid-state battery cell were fabricated in the same manner as in Example 1.

### Example 3

22.94 wt % of carbon black with an average particle diameter (D50) of 35 nm, 68.8 wt % of Ag with an average size of 60 nm, 6.88 wt % of a styrene-butadiene rubber (a weight average molecular weight (Mw): 50,000 g/mol), and 1.38 wt % of a sodium salt of carboxymethyl cellulose (a degree of substitution (DS): 0.8) were mixed in water to prepare a negative electrode coating layer slurry.

Except for using the negative electrode coating layer slurry, a negative electrode and an all-solid-state battery cell were fabricated in the same manner as in Example 1.

### Comparative Example 1

22.94 wt % of carbon black with an average particle diameter (D50) of 35 nm, 68.8 wt % of Ag with an average size of 60 nm, and 8.26 wt % of polyvinylidene fluoride (PVdF) were mixed in N-methyl pyrrolidone to prepare a negative electrode coating layer slurry.

Except for using the negative electrode coating layer slurry, a negative electrode and an all-solid-state battery cell were fabricated in the same manner as in Example 1.

(Comparative Example 2) 22.94 wt % of carbon black with an average particle diameter (D50) of 35 nm, 68.8 wt % of Ag with an average size of 60 nm, 5.51 wt % of a styrene-butadiene rubber (a weight average molecular weight (Mw): 50,000 g/mol), and 2.75 wt % of a sodium salt of carboxymethyl cellulose (a degree of substitution (DS): 0.8) were mixed in water to prepare a negative electrode coating layer slurry.

Except for using the negative electrode coating layer slurry, a negative electrode and an all-solid-state battery cell were fabricated in the same manner as in Example 1.

### Comparative Example 3

22.94 wt % of carbon black with an average particle diameter (D50) of 35 nm, 68.8 wt % of Ag with an average size of 60 nm, 4.95 wt % of a styrene-butadiene rubber (a weight average molecular weight (Mw): 50,000 g/mol), and 3.31 wt % of a sodium salt of carboxymethyl cellulose (a degree of substitution (DS): 0.8) were mixed in water to prepare a negative electrode coating layer slurry.

Except for using the negative electrode coating layer slurry, a negative electrode and an all-solid-state battery cell were fabricated in the same manner as in Example 1.

### Comparative Example 4

22.94 wt % of carbon black with an average particle diameter (D50) of 35 nm, 68.8 wt % of Ag with an average size of 60 nm, 4.13 wt % of a styrene-butadiene rubber (a weight average molecular weight (Mw): 50,000 g/mol), and 4.13 wt % of a sodium salt of carboxymethyl cellulose (a degree of substitution (DS): 0.8) were mixed in water to prepare a negative electrode coating layer slurry.

Except for using the negative electrode coating layer slurry, a negative electrode and an all-solid-state battery cell were fabricated in the same manner as in Example 1.

### Comparative Example 5

22.94 wt % of carbon black with an average particle diameter (D50) of 35 nm, 68.8 wt % of Ag with an average size of 60 nm, 2.76 wt % of a styrene-butadiene rubber (a weight average molecular weight (Mw): 50,000 g/mol), and 5.50 wt % of a sodium salt of carboxymethyl cellulose (a degree of substitution (DS): 0.8) were mixed in water to prepare a negative electrode coating layer slurry.

Except for using the negative electrode coating layer slurry, a negative electrode and an all-solid-state battery cell were fabricated in the same manner as in Example 1.

### Comparative Example 6

22.62 wt % of carbon black with an average particle diameter (D50) of 35 nm, 67.85 wt % of Ag with an average size of 60 nm, 8.26 wt % of a styrene-butadiene rubber (a weight average molecular weight (Mw): 50,000 g/mol), and 1.27 wt % of a sodium salt of carboxymethyl cellulose (a degree of substitution (DS): 0.8) were mixed in water to prepare a negative electrode coating layer slurry.

Except for using the negative electrode coating layer slurry, a negative electrode and an all-solid-state battery cell were fabricated in the same manner as in Example 1.

### Comparative Example 7

22.94 wt % of carbon black with an average particle diameter (D50) of 35 nm, 68.80 wt % of Ag with an average size of 60 nm, 6.2 wt % of polyvinyl pyrrolidone (a weight average molecular weight (Mw): 1,300,000 g/mol), and 2.06 wt % of carboxymethyl cellulose (a degree of substitution (DS): 0.8) were mixed in water to prepare a negative electrode coating layer slurry.

Except for using the negative electrode coating layer slurry, a negative electrode and an all-solid-state battery cell were fabricated in the same manner as in Example 1.

### Experimental Example 1) Evaluation of Peeling Phenomenon

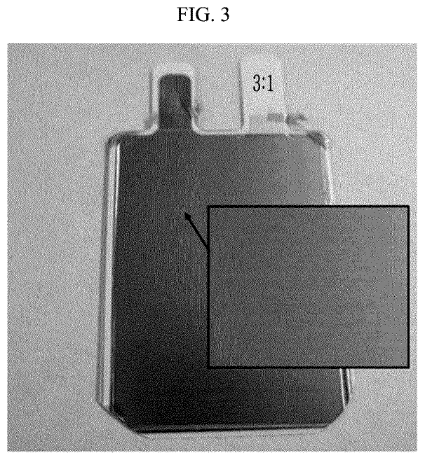

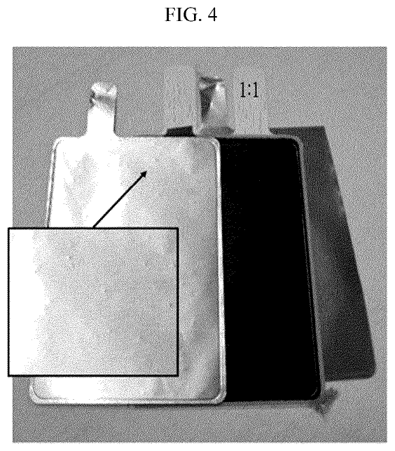

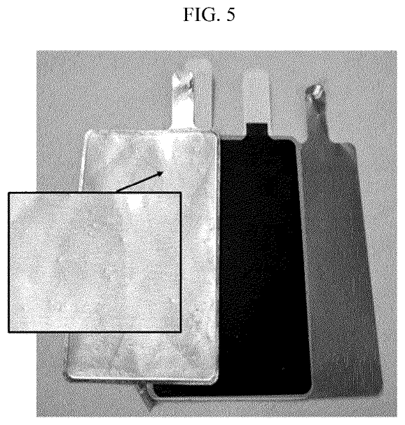

After performing the warm isotropic pressure process in the all-solid-state battery fabricating process according to Examples 1 to 3 and Comparative Examples 1 to 7, the cells were evaluated with respect to peeling phenomenon between negative electrode coating layer and current collector. Among the results, the result of Example 1 is provided in FIG. 3, the result of Comparative Example 4 is shown in FIG. 4, and the result of Comparative Example 5 is shown in FIG. 5.

As shown in FIG. 3, the all-solid-state battery cell of Example 1 exhibited that the negative electrode coating layer was not peeled off but maintained the stacked state with the current collector, and in addition, even if looking to a partially enlarged photograph, the smooth surface was kept with no coagulation.

On the other hand, Comparative Examples 4 and 5 shown in FIGS. 4 and 5 exhibited that the current collector (a bright layer on the left) and the negative electrode coating layer (a black portion in the middle) were separated each other, which confirmed that the negative electrode coating layer was peeled off. In addition, referring to a gray color presented behind the black color was also the current collector in the second unit cell, the current collector was peeled off and separated from the negative electrode coating layer. Furthermore, referring to a partially enlarged photograph, it was confirmed that coagulation occurred.

Accordingly, even if a rubber-based binder and a sodium salt of carboxymethyl cellulose were used as a binder, if their mixing ratio was 1:1 or 0.5:1, it was clearly confirmed that adhesive strength was insufficient.

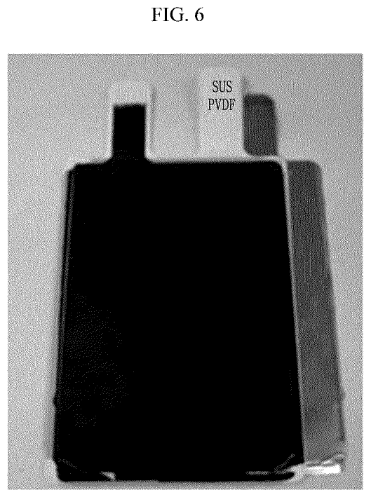

In addition, the result of evaluating the peeling phenomenon of Comparative Example 1 using a polyvinylidene fluoride (PVDF) binder is shown in FIG. 6. Herein, the current collector in contact with the coating layer was separated and peeled off and thus not seen in FIG. 6, but the current collector located at the bottom in gray was one peeled off from the negative electrode coating layer included in the second unit cell.

Referring to the results, if the rubber-based binder and the sodium salt of carboxymethyl cellulose were used in a weight ratio of greater than 2:1 to 5:1, the negative electrode manufacturing process was improved.

### Experimental Example 2) Evaluation of Charge/Discharge Efficiency

The all-solid-state battery cells of Examples 1 to 3, and Comparative Examples 1 to 7 were once charged and discharged at 0.1 C and once charged and discharged at 1 C at 0.33 C. The cells were measured with respect to charge capacity and discharge capacity, and the results are shown in Table 1. In addition, a ratio of the discharge capacity to the charge capacity (1st discharge capacity/1st charge capacity) was calculated, and the result is shown as efficiency in Table 1.

In addition, the mixing ratios of the styrene-butadiene rubber (SBR) and the sodium salt of carboxymethyl cellulose (Na-CMC) used in Examples 1 to 3 and Comparative Examples 1 to 7 are summarized in Table 1. The polyvinyl pyrrolidone used in Comparative Example 7 is shown as PVP.

### Experimental Example 3) Cycle-Life Evaluation

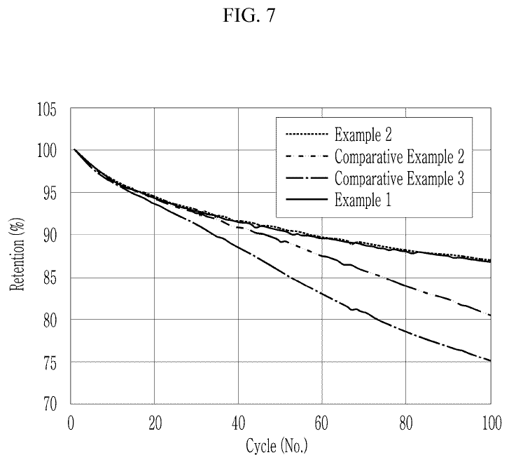

The all-solid-state battery cells according to Examples 1 to 3 and Comparative Examples 1 to 7 were once charged and discharged at 0.1 C and 100 times charged and discharged at 0.33 C. A capacity ratio of capacity at each cycle to 1st discharge capacity at 0.1 C was calculated. Among the results, the results of Examples 1 and 2 and Comparative Examples 2 and 3 are shown as retention in FIG. 7. In addition, a capacity ratio of 100th discharge capacity at 0.33 C to the 1st discharge capacity at 0.1 C was calculated and then, shown as cycle-life characteristics in Table 1.

TABLE 1

| | | | | Charge | Discharge | | |
|---|---|---|---|---|---|---|---|
| | SBR:CMC-Na | | | capacity | capacity | Efficiency | Cycle-life |
| | weight ratio | C-rate | | (mAh/g) | (mAh/g) | (%) | (%) |
| Example 1 | 3:1 | 10.1 | C | 242.8 | 209.3 | 86.2 | |
| | 3:1 | 0.33 | C | 208.6 | 196.0 | 93.9 | 88.4 |
| | 3:1 | 1.0 | C | 195.6 | 181.0 | 92.6 | |
| Example 2 | 2.5:1 | 0.1 | C | 242.1 | 208.7 | 86.2 | |
| | 2.5:1 | 0.33 | C | 207.8 | 195.1 | 93.9 | 87.8 |
| | 2.5:1 | 1.0 | C | 194.7 | 180.9 | 92.9 | |
| Example 3 | 5:1 | 0.1 | C | 236.4 | 206.4 | 87.3 | |
| | 5:1 | 0.33 | C | 205.3 | 192.2 | 93.6 | 85.0 |
| | 5:1 | 1.0 | C | 191.4 | 172.9 | 90.4 | |
| Comparative | —(PVdF was used) | 0.1 | C | 242.2 | 208.5 | 86.1 | |
| Example 1 | —(PVdF was used) | 0.33 | C | 207.5 | 194.8 | 93.9 | 84.5 |
| | —(PVdF was used) | 1.0 | C | 194.3 | 179.9 | 92.6 | |
| Comparative | 2:1 | 0.1 | C | 235.8 | 203.3 | 86.2 | |
| Example 2 | 2:1 | 0.33 | C | 201.8 | 188.3 | 93.3 | 83.9 |
| | 2:1 | 1.0 | C | 187.5 | 172.0 | 91.7 | |
| Comparative | 1.5:1 | 0.1 | C | 235.5 | 204.1 | 86.7 | |
| Example 3 | 1.5:1 | 0.33 | C | 202.7 | 188.9 | 93.2 | 78.4 |
| | 1.5:1 | 1.0 | C | 188.1 | 172.5 | 91.7 | |
| Comparative | 1:1 | 0.1 | C | 235.1 | 203.7 | 86.6 | |
| Example 4 | 1:1 | 0.33 | C | 202.3 | 186.9 | 92.4 | 76.3 |
| | 1:1 | 1.0 | C | 186.0 | 169.8 | 91.3 | |
| Comparative | 0.5:1 | 0.1 | C | 232.7 | 201.5 | 86.6 | |
| Example 5 | 0.5:1 | 0.33 | C | 200.4 | 180.2 | 89.9 | 63.2 |
| | 0.5:1 | 1.0 | C | 178.9 | 163.1 | 91.2 | |
| Comparative | 5.5:1 | 0.1 | C | 234.7 | 202.9 | 86.5 | |
| Example 6 | 5.5:1 | 0.33 | C | 201.8 | 183.4 | 90.9 | 78.5 |
| | 5.5:1 | 1.0 | C | 182.0 | 165.7 | 91.0 | |
| Comparative | 3 (PVP):1 | 0.1 | C | 242.3 | 211.1 | 87.1 | |
| Example 7 | 3 (PVP):1 | 0.33 | C | 207.1 | 191.0 | 92.2 | 82.7 |
| | 3 (PVP):1 | 1.0 | C | 188.7 | 171.9 | 91.0 | |

As shown in Table 1, the all-solid-state battery cells of Examples 1 to 3 including the rubber-based binder and the sodium salt of carboxymethyl cellulose in a weight ratio of greater than 2:1 to 5:1, compared with those of Comparative Examples 2 to 6 including them by exceeding the weight ratio, exhibited excellent efficiency and cycle-life characteristics. In addition, the all-solid-state battery cells of Examples 1 to 3, compared with Comparative Example 1 using the polyvinylidene fluoride binder, exhibited a little superior efficiency and cycle-life characteristics. Comparative Example 1 exhibited cycle-life characteristics of 84.5%, which did not reach 85% required for practically applying all-solid-state batteries. Accordingly, the all-solid-state battery cell of Comparative Example 1 turned out to be practically inapplicable.

In addition, Comparative Example 7 using the styrene-butadiene rubber along with polyvinylpyrrolidone exhibited deteriorated efficiency and cycle-life characteristics, compared with Examples 1 to 3.

In particular, as shown in FIG. 7, Examples 1 and 2 exhibited superior cycle-life characteristics to Comparative Examples 2 and 3.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A binder for a negative electrode of an all-solid-state battery, comprising a rubber-based binder and a sodium salt of carboxymethyl cellulose in a weight ratio of greater than 2:1 to 5:1.

2. The binder for a negative electrode of an all-solid-state battery as claimed in claim 1, wherein the all-solid-state battery is a precipitation-type all-solid-state battery.

3. The binder for a negative electrode of an all-solid-state battery as claimed in claim 1, wherein the rubber-based binder is a styrene butadiene rubber (SBR), a nitrile-butadiene rubber (NBR), a butadiene rubber (BR), a solution styrene butadiene rubber (SSBR), an ethylene propylene diene terpolymer (EPDM), or a combination thereof.

4. The binder for a negative electrode of an all-solid-state battery as claimed in claim 1, wherein a weight ratio of the rubber-based binder and a sodium salt of carboxymethyl cellulose is 2.5:1 to 5:1.

5. The binder for a negative electrode of an all-solid-state battery as claimed in claim 1, wherein a weight average molecular weight (Mw) of the rubber-based binder is 5,000 g/mol to 1,000,000 g/mol.

6. The binder for a negative electrode of an all-solid-state battery as claimed in claim 1, wherein a degree of substitution of the carboxymethyl cellulose sodium salt is 0.3 to 1.0.

7. A negative electrode for an all-solid-state battery, comprising a current collector; and
a negative electrode layer located on the current collector and including a binder according to any one of claims 1 to 6 claim 1.

8. The negative electrode for an all-solid-state battery as claimed in claim 7, wherein the negative electrode layer further includes a metal and amorphous carbon.

9. The negative electrode for an all-solid-state battery as claimed in claim 8, wherein the metal includes Ag, Au, Sn, Zn, Al, Mg, Ge, Cu, In, Ni, Bi, Pt, Pd, or a combination thereof.

10. The negative electrode for an all-solid-state battery as claimed in claim 8, wherein the amorphous carbon includes carbon black, acetylene black, denka black, ketjen black, furnace black, activated carbon, or a combination thereof.

11. An all-solid-state battery, comprising
the negative electrode as claimed in claim 7;
a positive electrode; and
a solid electrolyte layer between the negative electrode and the positive electrode.

12. The all-solid-state battery as claimed in claim 11, wherein the solid electrolyte is a sulfide-based solid electrolyte.

13. The all-solid-state battery as claimed in claim 11, wherein the all-solid-state battery further includes a lithium-containing layer formed between the current collector and the negative electrode layer if charged.
